(19) United States
(12) Patent Application Publication
(10) Pub. No.: US 2019/0051927 A1
(43) Pub. Date: Feb. 14, 2019

(54) LITHIUM-ION SECONDARY BATTERY

(71) Applicant: HITACHI CHEMICAL COMPANY, LTD., Tokyo (JP)

(72) Inventors: Ryuichiro FUKUTA, Chiyoda-ku, Tokyo (JP); Katsunori KOJIMA, Chiyoda-ku, Tokyo (JP); Yuma GOGYO, Chiyoda-ku, Tokyo (JP)

(21) Appl. No.: 16/079,006

(22) PCT Filed: Dec. 9, 2016
(86) PCT No.: PCT/JP2016/086798

§ 371 Date: Aug. 22, 2018

(30) Foreign Application Priority Data
Feb. 26, 2016 (JP) 2016-035313

(51) Int. Cl. H01M 10/0525; H01M 4/485; H01M 10/0569; H01M 4/505; H01M 4/525

(52) U.S. Cl. CPC H01M 10/0525; H01M 4/485; H01M 2004/028; H01M 4/505; H01M 4/525; H01M 10/0569

(57) ABSTRACT

A lithium-ion secondary battery contains: a positive electrode including a lithium nickel manganese complex oxide as a positive electrode active material; a negative electrode; and an electrolyte solution; in which the electrolyte solution includes dimethyl carbonate as a nonaqueous solvent, and an end-of-charge voltage is in a range from 3.4 V to 3.8 V and an end-of-discharge voltage is in a range from 2.0 V to 2.8 V.

### TECHNICAL FIELD

The present invention relates to a lithium-ion secondary battery.

### BACKGROUND ART

A lithium-ion secondary battery is a secondary battery having a high volumetric energy density, and is used as a power source for a portable device, such as a notebook computer, and a cell phone, utilizing such characteristics.

In recent years, for use as a power source for an electronic device, a power source for power storage, a power source for an electric car or the like for which a movement toward higher performance and downsizing is advancing, a lithium-ion secondary battery having a high energy density has drawn attention.

The method of enhancement in energy density of a lithium-ion secondary battery is, for example, a method in which a positive electrode active material exhibiting a high operating potential is used in a positive electrode. The positive electrode active material exhibiting a high operating potential, currently known, is a lithium nickel manganese complex oxide such as LiNi_{0.5}Mn_{1.5}O₄ (see, for example, Patent Documents 1 to 3).

### RELATED ART DOCUMENT

### Patent Document

Patent Document 1: Japanese Patent Application Laid-Open (JP-A) No. 2001-185148
Patent Document 2: JP-A No. 2002-158007
Patent Document 3: JP-A No. 2003-81637

### SUMMARY OF INVENTION

### Technical Problem

However, in a case in which a lithium nickel manganese complex oxide is used as a positive electrode active material, a lithium-ion secondary battery sometimes causes decrease in an initial capacity, and a charge and discharge cycle performance.

The present invention is made in view of the above circumstances and aims to provide a lithium-ion secondary battery having a positive electrode including a lithium nickel manganese complex oxide as a positive electrode active material with excellent in an initial capacity, and a charge and discharge cycle performance.

### Solution to Problem

Specific embodiments for achieving the object include the following embodiments.

<1> A lithium-ion secondary battery containing:

a positive electrode including a lithium nickel manganese complex oxide as a positive electrode active material;

a negative electrode; and

an electrolyte solution; in which

the electrolyte solution includes dimethyl carbonate as a nonaqueous solvent, and

an end-of-charge voltage is in a range from 3.4 V to 3.8 V and an end-of-discharge voltage is in a range from 2.0 V to 2.8 V.

<2> The lithium-ion secondary battery according to <1>, in which the end-of-discharge voltage is in a range from 2.6 V to 2.8 V.

<3> The lithium-ion secondary battery according to <1> or <2>, in which a content of the dimethyl carbonate is more than 70% by volume with respect to a total amount of the nonaqueous solvent.

<4> The lithium-ion secondary battery according to any one of <1> to <3>, in which the negative electrode includes a lithium titanium complex oxide as a negative electrode active material.

### ADVANTAGEOUS EFFECTS OF INVENTION

According to the present invention, it is possible to provide a lithium-ion secondary battery having a positive electrode including a lithium nickel manganese complex oxide as a positive electrode active material with excellent in an initial capacity, and a charge and discharge cycle performance.

### BRIEF DESCRIPTION OF DRAWINGS

FIG. 1 is a perspective cross-sectional view illustrating one example of a 18650 (cylindrical) lithium-ion secondary battery.

FIG. 2 is a perspective view illustrating one example of a laminated lithium-ion secondary battery.

FIG. 3 is a perspective view illustrating a positive plate, a negative plate and a separator forming an electrode assembly of the lithium-ion secondary battery in FIG. 2.

### DESCRIPTION OF EMBODIMENTS

Hereinafter, embodiments of the present invention will be described in detail. However, the present invention is not limited to the following embodiments. In the following embodiments, the constituent elements (including the element steps and the like) are not indispensable except when particularly explicitly mentioned, when it is considered to be obviously indispensable in principle, or the like. The same applies to numerical values and ranges thereof, and does not limit the present invention.

In the disclosures, each numerical range specified using “(from) . . . to . . . ” represents a range including the numerical values noted before and after “to” as the minimum value and the maximum value, respectively.

In the disclosures, with respect to numerical ranges stated hierarchically herein, the upper limit or the lower limit of a numerical range of a hierarchical level may be replaced with the upper limit or the lower limit of a numerical range of another hierarchical level. Further, in the present specification, with respect to a numerical range, the upper limit or the lower limit of the numerical range may be replaced with a relevant value shown in any of Examples.

In referring herein to a content of a component in a composition, when plural kinds of substances exist corresponding to a component in the composition, the content means, unless otherwise specified, the total amount of the plural kinds of substances existing in the composition.

In referring herein to a particle diameter of a component in a composition, when plural kinds of particles exist corresponding to a component in the composition, the particle diameter means, unless otherwise specified, a value with respect to the mixture of the plural kinds of particles existing in the composition.

The term “layer” comprehends herein not only a case in which the layer is formed over the whole observed region where the layer is present, but also a case in which the layer is formed only on part of the region.

The term “layered” as used herein indicates “provided on or above”, in which two or more layers may be bonded or detachable.

In the disclosures, the “solid mass” of the positive electrode material mixture or the negative electrode material mixture means a remaining component obtained by removing a volatile component such as an organic solvent from the positive electrode material mixture or the negative electrode material mixture.

[Lithium-ion Secondary Battery]

A lithium-ion secondary battery in the present embodiment contains: a positive electrode including a lithium nickel manganese complex oxide as a positive electrode active material; a negative electrode; and an electrolyte solution; in which the electrolyte solution includes dimethyl carbonate as a nonaqueous solvent, and an end-of-charge voltage is in a range from 3.4 V to 3.8 V and an end-of-discharge voltage is in a range from 2.0 V to 2.8 V.

In a case in which the electrolyte solution includes dimethyl carbonate as a nonaqueous solvent, there is a tendency that a charge and discharge cycle performance is enhanced in the lithium-ion secondary battery whose a positive electrode includes a lithium nickel manganese complex oxide as a positive electrode active material. The reason for this is considered because dimethyl carbonate is excellent in oxidation resistance, and is hardly oxidized and decomposed on the positive electrode even in use of a high-potential lithium nickel manganese complex oxide as a positive electrode active material. Dimethyl carbonate is also excellent in reduction resistance, and therefore is hardly reduced and decomposed on the negative electrode even in use of a lithium titanium complex oxide or the like as a negative electrode active material.

In a case in which an end-of-charge voltage is 3.4 V or more in the lithium-ion secondary battery whose a positive electrode includes a lithium nickel manganese complex oxide as a positive electrode active material, there is a tendency that sufficient charge is imparted to enhance an initial capacity. The end-of-charge voltage is preferably 3.5 V or more. In a case in which the end-of-charge voltage is 3.8 V or less, there is a tendency that the electrolyte solution is inhibited from being decomposed due to an increase in the potential of the positive electrode in charge to enhance a charge and discharge cycle performance. The end-of-charge voltage is preferably 3.7 V or less.

Meanwhile, in a case in which the end-of-discharge voltage is 2.0 V or more, there is a tendency that the electrolyte solution is inhibited from being decomposed due to an increase in the potential of the negative electrode in discharge to enhance a charge and discharge cycle performance. The end-of-discharge voltage is preferably 2.6 V or more. In a case in which the end-of-discharge voltage is 2.6 V or more, there is a tendency that a charge and discharge may be avoided in the redox region for manganese included in the positive electrode active material to enhance a charge and discharge cycle performance. The reason why charge and discharge in the redox region for manganese is avoided to enhance in charge and discharge cycle performance, is not clear, but is presumed as follows. The Jahn-Teller effect causes a crystallite of the positive electrode active material to be expanded and contracted according to charge and discharge in the redox region for manganese, resulting in breaking of the positive electrode active material. Therefore, it is considered that charge and discharge in the redox region for manganese is avoided, thereby resulting in an enhancement in charge and discharge cycle performance. In a case in which the end-of-discharge voltage is 2.8 V or less, there is a tendency that a sufficient charge is imparted to enhance an initial capacity.

The end-of-charge voltage is preferably in a range from 3.5 V to 3.7 V and the end-of-discharge voltage is preferably in a range from 2.6 V to 2.8 V from the viewpoint of providing a lithium-ion secondary battery satisfying an initial capacity and a charge and discharge cycle performance in a more balanced manner.

The end-of-charge voltage and the end-of-discharge voltage each mean a voltage per single battery. In the case of an assembled battery formed from a plurality of batteries, the end-of-charge voltage and the end-of-discharge voltage each mean a voltage set with respect to each single battery.

The positive electrode active material and the negative electrode active material of the lithium-ion secondary battery in the present embodiment will be hereinafter described, and the overall structure of the lithium-ion secondary battery will be then described.

<Positive Electrode Active Material>

For a lithium-ion secondary battery in the present embodiment, a positive electrode active material including a lithium nickel manganese complex oxide is used. From the viewpoint of improvement energy density, a content of a lithium nickel manganese complex oxide is preferably from 60% by mass to 100% by mass with respect to a total amount of a positive electrode active material, more preferably from 70% by mass to 100% by mass, and still more preferably from 85% by mass to 100% by mass.

A lithium nickel manganese complex oxide preferably has a spinel structure. A lithium nickel manganese complex oxide having a spinel structure is preferably a compound represented by LiNiₓMn_{2-X}O₄ (0.3<X<0.7), more preferably a compound represented by LiNi_{X}Mn_{2-X}O₄ (0.4<X<0.6), and from the viewpoint of stability still more preferably LiNi_{0.5}Mn_{1.5}O₄.

For stabilizing further the crystal structure of a lithium nickel manganese complex oxide having a spinel structure, a lithium nickel manganese complex oxide having a spinel structure, which Mn, Ni and/or O sites are partially substituted with another element, may be used.

Further, excessive lithium may be made present in a crystal of a lithium nickel manganese complex oxide having a spinel structure. Furthermore, a lithium nickel manganese complex oxide having a spinel structure, which O site is made to have a defect, may be used.

Examples of a metal element able to replace a Mn or a Ni site of a lithium nickel manganese complex oxide having a spinel structure include Ti, V, Cr, Fe, Co, Zn, Cu, W, Mg, Al, and Ru. A Mn or a Ni site of a lithium nickel manganese complex oxide having a spinel structure may be substituted with one kind, or two or more kinds of the metal elements. Among the substitutable metal elements, use of Ti as a substitutable metal is preferable from the viewpoint of further stabilization of the crystal structure of a lithium nickel manganese complex oxide having a spinel structure.

Examples of another substitutable element for an O site of a lithium nickel manganese complex oxide having a spinel structure include F and B. An O site of a lithium nickel manganese complex oxide having a spinel structure may be substituted with one, or two or more kinds of such other elements. Among such other substitutable elements, use of F is preferable from the viewpoint of further stabilization of the crystal structure of a lithium nickel manganese complex oxide having a spinel structure.

From the viewpoint of high energy density, the electric potential of the lithium nickel manganese complex oxide in a full charged state with respect to Li/Li⁺ is preferably from 4.5 V to 5 V, and more preferably from 4.6 V to 4.9 V. The “full charged state” means a state that a SOC (state of charge) is 100%

From the viewpoint of improvement of storage characteristics, a BET specific surface area of a lithium nickel manganese complex oxide is preferably less than 2.9 m²/g, more preferably less than 2.8 m²/g, still more preferably less than 1.5 m²/g, and further more preferably less than 0.3 m²/g. From the viewpoint of improvement of input-output performance, the BET specific surface area of a lithium nickel manganese complex oxide is preferably 0.05 m²/g or more, more preferably 0.08 m²/g or more, and still more preferably 0.1 m²/g or more.

The BET specific surface area of a lithium nickel manganese complex oxide is preferably 0.05 m²/g or more and less than 2.9 m²/g, more preferably 0.05 m²/g or more and less than 2.8 m²/g, still more preferably0.08 m²/g or more and less than 1.5 m²/g, and further more preferably 0.1 m²/g or more and less than 0.3 m²/g.

The BET specific surface area may be measured, for example, based on a nitrogen adsorption capacity according to JIS Z 8830:2013. Examples for a measuring apparatus include an AUTOSORB-1 (trade name) manufactured by Quantachrome Instruments. In measuring the BET specific surface area, moisture adsorbed on a surface of a sample or in the structure thereof may conceivably influence the gas adsorption capacity, and therefore a pretreatment for removing moisture by heating is preferably conducted firstly. In the pretreatment, a measurement cell loaded with 0.05 g of a measurement sample is evacuated by a vacuum pump to be 10 Pa or less, then heated at 110° C. for a duration of 3 hours or longer, and cooled naturally to normal temperature (25° C.) while maintaining the reduced pressure. After the pretreatment, the measurement temperature is lowered to 77K and a measurement is conducted in a measurement pressure range of less than 1 in terms of relative pressure which is namely an equilibrium pressure with respect to a saturated vapor pressure.

From the viewpoint of a particle dispersibility, the median diameter D50 of a particle of a lithium nickel manganese complex oxide (in a case in which primary particles aggregate to form a secondary particle, the median diameter D50 means the secondary particle) is preferably from 0.5 μm to 100 μm, and more preferably from 1 μm to 50 μm.

In this regard, a median diameter D50 may be determined from a particle size distribution obtained by a laser diffraction scattering method. Specifically, a lithium nickel manganese complex oxide is added into pure water at 1% by mass, and dispersed ultrasonically for 15 min, and then a measurement by a laser diffraction scattering method is performed.

A positive electrode active material in a lithium-ion secondary battery in the present embodiment may include a positive electrode active material other than a lithium nickel manganese complex oxide.

Examples of another positive electrode active material include LiₓCoO₂, LiₓNiO₂, LiₓMnO₂, LiₓCo_{y}Ni_{1-y}O₂, LiₓCo_{y}M¹_{1-y}O_{z} (in the formula, M¹ represents at least one element selected from the group consisting of Na, Mg, Sc, Y, Mn, Fe, Cu, Zn, Al, Cr, Pb, Sb, V, and B), LiₓNi_{1-y}M²_{y}O_{z} (in the formula, M² represents at least one element selected from the group consisting of Na, Mg, Sc, Y, Mn, Fe, Cu, Zn, Al, Cr, Pb, Sb, V, and B), LiₓMn₂O₄ and LiₓMn_{2-y}M³_{y}O₄ (in the formula, M3 represents at least one element selected from the group consisting of Na, Mg, Sc, Y, Fe, Cu, Zn, Al, Cr, Pb, Sb, V, and B), in each Formula, 0<x≤1.2, 0≤y≤0.9, and 2.0≤z≤2.3. In this case, an x value representing a molar ratio of lithium varies depending by charge and discharge.

When another positive electrode active material is included as a positive electrode active material, a BET specific surface area of such another positive electrode active material is, from the viewpoint of improvement of storage characteristics, preferably less than 2.9 m²/g, more preferably less than 2.8 m²/g, still more preferably less than 1.5 m²/g, and further more preferably less than 0.3 m²/g. From the viewpoint of improvement input-output performance, the BET specific surface area is preferably 0.05 m²/g or more, more preferably 0.08 m²/g or more, and still more preferably 0.1 m²/g or more.

The BET specific surface area of such another positive electrode active material is preferably 0.05 m²/g or more and less than 2.9 m²/g, more preferably 0.05 m²/g or more and less than 2.8 m²/g, still more preferably 0.08 m²/g or more and less than 1.5 m²/g, and further more preferably 0.1 m²/g or more and less than 0.3 m²/g.

The BET specific surface area of such another positive electrode active material may be measured by a method similar to a lithium nickel manganese complex oxide having a spinel structure.

When another positive electrode active material is included as a positive electrode active material, the median diameter D50 of a particle of such another positive electrode active material (in a case in which primary particles aggregate to form a secondary particle, the median diameter D50 means the secondary particle) is, from the viewpoint of a particle dispersibility, preferably from 0.5 μm to 100 μm, and more preferably from 1μm to 50 μm. In this regard, a median diameter D50 of such another positive electrode active material may be measured by a method similar to that for a lithium nickel manganese complex oxide.

<Negative Electrode Active Material>

There is no particular restriction on a negative electrode active material in the present embodiment. The negative electrode active material may include a lithium titanium complex oxide, a molybdenum oxide, an iron sulfide, a titanium sulfide, a carbon material. Among them, the negative electrode active material preferably includes a lithium titanium complex oxide. From the viewpoint of safety, a content of a lithium titanium complex oxide is preferably from 70% by mass to 100% by mass with respect to the total amount of a negative electrode active material, more preferably from 80% by mass to 100% by mass, and still more preferably from 90% by mass to 100% by mass.

A lithium titanium complex oxide is preferably a lithium titanium complex oxide having a spinel structure. A basic compositional formula of a lithium titanium complex oxide having a spinel structure is represented by Li[Li_{1/3}Ti_{5/3}]O₄.

For further stabilization of the crystal structure of a lithium titanium complex oxide having a spinel structure, a part of Li, Ti, or O sites of a lithium titanium complex oxide having a spinel structure may be substituted with another element.

Further, excessive lithium may be made present in a crystal of a lithium titanium complex oxide having a spinel structure. Furthermore, a lithium titanium complex oxide having a spinel structure, which O site is made to have a defect, may be used.

Examples of a metal element able to replace a Li or Ti site of a lithium titanium complex oxide having a spinel structure include Nb, V, Mn, Ni, Cu, Co, Zn, Sn, Pb, Al, Mo, Ba, Sr, Ta, Mg, and Ca. A Li or Ti site of a lithium titanium complex oxide having a spinel structure may be substituted with one kind, or two or more kinds of these metal elements.

Examples of another element able to replace an O site of a lithium titanium complex oxide having a spinel structure include F and B. An O site of a lithium titanium complex oxide having a spinel structure may be substituted with one kind, or two or more kinds of such other elements.

The electric potential of the lithium titanium complex oxide in a full charged state is preferably from 1 V to 2 V with respect to Li/Li⁺.

From the viewpoint of improvement of storage characteristics, a BET specific surface area of a negative electrode active material is preferably less than 2.9 m²/g, more preferably less than 2.8 m²/g, still more preferably less than 1.5 m²/g, and further more preferably less than 0.3 m²/g. From the viewpoint of improvement of input-output performance, the BET specific surface area of a negative electrode active material is preferably 0.05 m²/g or more, more preferably 0.08 m²/g or more, and still more preferably 0.1 m²/g or more.

The BET specific surface area of a negative electrode active material is preferably 0.05 m²/g or more and less than 2.9 m²/g, more preferably 0.05 m²/g or more and less than 2.8 m²/g, still more preferably 0.08 m²/g or more and less than 1.5 m²/g, and further more preferably 0.1 m²/g or more and less than 0.3 m²/g.

The BET specific surface area of a negative electrode active material may be measured by a method similar to that for a lithium nickel manganese complex oxide having a spinel structure.

From the viewpoint of a particle dispersibility, the median diameter D50 of a particle of a negative electrode active material (in a case in which primary particles aggregate to form a secondary particle, the median diameter D50 means the secondary particle) is preferably from 0.5 μm to 100 μm, and more preferably from 1 μm to 50 μm.

A median diameter D50 of a negative electrode active material may be measured by a method similar to that for a lithium nickel manganese complex oxide having a spinel structure.

<Overall Structure of Lithium-ion Secondary Battery>

A lithium-ion secondary battery in the present embodiment has a positive electrode, a negative electrode, and an electrolyte solution. A separator is provided between the positive electrode and the negative electrode.

(Positive Electrode)

A positive electrode has, for example, a current collector, a positive electrode material mixture layer provided on a single side or both sides of the current collector. The positive electrode material mixture layer contains the positive electrode active material as described above.

A material for a current collector of a positive electrode includes aluminum, titanium, stainless steel, nickel, and electrically conductive polymer, in addition to aluminum, copper, or the like, whose surface is subjected to a treatment for sticking carbon, nickel, titanium, silver, or the like thereto for the purpose of improvement of adhesiveness, electrical conductivity, oxidation resistance or the like.

A positive electrode is, for example, prepared by mixing a positive electrode active material and a electroconductive material, if necessary adding an appropriate binder and a solvent, to form a pasty positive electrode material mixture, and coating the pasty positive electrode material mixture onto a surface of a current collector, followed by drying, and then, if necessary, by increasing a density of a positive electrode material mixture layer by pressing or the like.

The electroconductive material is an ingredient for improving an electric conductivity of an electrode, and includes carbon substance powders including a carbon black, acetylene black, Ketjenblack, graphite. Furthermore, the electroconductive material may additionally contain a small amount of carbon nanotube, graphene, or the like in order to improve the electric conductivity. The electroconductive material may be used singly, or in a combination of two or more thereof

The range of the content of the electroconductive material with respect to the total solid amount of a positive electrode material mixture is as follows. From the viewpoint of superior input-output performance, the lower limit of the range is preferably 0.01% by mass or more, more preferably 0.1% by mass or more, and still more preferably 1% by mass or more. From the viewpoint of improvement of battery capacity, the upper limit is preferably 50% by mass or less, more preferably 30% by mass or less, and still more preferably 15% by mass or less.

The binder is not particularly limited, and a material having superior solubility or dispersibility in a dispersing solvent is selected as the binder. Specific examples thereof include: a resin polymer such as polyethylene, polypropylene, poly(ethylene terephthalate), poly(methyl methacrylate), polyimide, aromatic polyamide, cellulose, or nitrocellulose; a rubber polymer such as SBR (styrene-butadiene rubber), NBR (acrylonitrile-butadiene rubber), fluorinated rubber, isoprene rubber, butadiene rubber, or ethylene-propylene rubber; a thermoplastic elastomer polymer such as a styrene-butadiene-styrene block copolymer or a hydrogenated product thereof, an EPDM (ethylene-propylene-diene terpolymer), or a styrene-isoprene-styrene block copolymer or a hydrogenated product thereof; a soft resin polymer such as syndiotactic 1,2-polybutadiene, poly(vinyl acetate), an ethylene-vinyl acetate copolymer, or a propylene-a-olefin copolymer; a fluorocarbon polymer such as poly(vinylidene fluoride) (PVdF), polytetrafluoroethylene, fluorinated poly(vinylidene fluoride), a polytetrafluoroethylene-ethylene copolymer, or a polytetrafluoroethylene-vinylidene fluoride copolymer; a copolymer obtained by adding acrylic acid and a straight chain ether group to a polyacrylonitrile structure; and a polymer composition having ion conductivity of an alkali metal ion (especially lithium ion). The binders may be used singly, or in a combination of two or more thereof. From the viewpoint of high adherence, use of poly(vinylidene-fluoride) (PVdF), or a copolymer obtained by adding acrylic acid and a straight chain ether group to a polyacrylonitrile structure is preferable, and from the viewpoint of further improvement in charge and discharge cycle performance, use of a copolymer obtained by adding acrylic acid and a straight chain ether group to a polyacrylonitrile structure is more preferable

The range of the content of a binder with respect to the total solid mass of a positive electrode material mixture is as follows. Regarding the lower limit, the content is preferably 0.1% by mass or more, more preferably 1% by mass or more, and further preferably 2% by mass or more, from the viewpoint of binding a positive electrode active material to obtain adequate mechanical strength of a positive electrode and to stabilize battery performance such as cycle performance. Regarding the upper limit, the content is preferably 30% by mass or less, more preferably 20% by mass or less, and further preferably 10% by mass or less, from the viewpoint of improvement of battery capacity and electrical conductivity. The content of a binder with respect to the total solid mass of a positive electrode material mixture is preferably from 0.1% by mass to 30% by mass, more preferably from 1% by mass to 20% by mass to, and further preferably from 2% by mass to 10% by mass.

The solvent used for dissolving or dispersing a positive electrode active material, an electroconductive material, a binder or the like includes an organic solvent such as N-methyl-2-pyrrolidone.

The coating amount of a positive electrode material mixture on a single side of a current collector is preferably from 100 g/m² to 250 g/m², more preferably from 110 g/m² to 200 g/m², further more preferably from 130 g/m² to 170 g/m², from the viewpoint of energy density and input-output performance.

The density of a positive electrode material mixture layer is preferably from 1.8 g/cm³ to 3.3 g/cm³, and more preferably from 2.0 g/cm³ to 3.2 g/cm³, further more preferably from 2.2 g/cm³ to 2.8 g/cm³, from the viewpoint of energy density and input-output performance.

<Negative Electrode>

A negative electrode has, for example, a current collector, a negative electrode material mixture layer provided on a single side or both sides of the current collector. The negative electrode material mixture layer contains the negative electrode active material as described above.

A material for a current collector of a negative electrode includes copper, stainless steel, nickel, aluminum, titanium, and electrically conductive polymer, aluminum-cadmium alloy, in addition to aluminum, copper or the like, whose surface is subjected to a treatment for sticking carbon, nickel, titanium, silver or the like thereto for the purpose of improvement of adhesiveness, electrical conductivity, oxidation resistance or the like.

A negative electrode is, for example, prepared by mixing a negative electrode active material and a electroconductive material, if necessary adding an appropriate binder and a solvent, to form a pasty negative electrode material mixture, and coating the pasty negative electrode material mixture onto a surface of a current collector, followed by drying, and then, if necessary, by increasing a density of a negative electrode material mixture layer by pressing or the like.

The electroconductive materials for a negative electrode are similar to the electroconductive materials for a positive electrode.

The content of the electroconductive material with respect to the total solid amount of a negative electrode material mixture is as follows. From the viewpoint of superior input-output performance, the lower limit of the range is preferably 0.01% by mass or more, more preferably 0.1% by mass or more, and still more preferably 1% by mass or more. From the viewpoint of improvement of battery capacity, the upper limit is preferably 45% by mass or less, more preferably 30% by mass or less, and still more preferably 15% by mass or less.

The binders for a negative electrode are similar to the binders for a positive electrode.

The range of the content of the binder with respect to the total solid amount of a negative electrode material mixture is as follows. Regarding the lower limit, the content is preferably 0.1% by mass or more, more preferably 0.5% by mass or more, and further preferably 1% by mass or more, from the viewpoint of binding a negative electrode active material to obtain adequate mechanical strength of a negative electrode and to stabilize battery performance such as cycle performance. Regarding the upper limit, the content is preferably 40% by mass or less, more preferably 25% by mass or less, and further preferably 15% by mass or less, from the viewpoint of improvement of battery capacity and electrical conductivity. The content of a binder with respect to the total solid mass of a negative electrode material mixture is preferably from 0.1% by mass to 40% by mass, more preferably from 0.5% by mass to 25% by mass to, and further preferably from 1% by mass to 15% by mass.

The solvent used for dissolving or dispersing a negative electrode active material, an electroconductive material, a binder or the like includes an organic solvent such as N-methyl-2-pyrrolidone.

<Separator>

There is no particular restriction on a separator, insofar as it has ion permeability while insulating electronically a positive electrode from a negative electrode, and is resistant to oxidizing environment at a positive electrode and to reducing environment at a negative electrode. As a material for a separator satisfying such characteristics, a resin, an inorganic substance, glass fiber or the like may be used.

As a resin, an olefinic polymer, a fluorinated polymer, a cellulosic polymer, polyimide, nylon or the like are used. Specifically, it should be preferably selected from materials which are stable against an electrolyte solution and superior in solution retention, and use of a porous sheet, or a nonwoven fabric made from polyolefin as a source material, such as polyethylene and polypropylene, is preferable. Further, in a case in which an average electric potential of a positive electrode is as high, one having a three-layer structure of polypropylene/polyethylene/polypropylene, in which polyethylene is sandwiched by polypropylene superior in resistance to high electric voltage, is also preferable.

As an inorganic substance, an oxide such as alumina and silicon dioxide, a nitride such as aluminum nitride and silicon nitride, a sulfate such as barium sulfate and calcium sulfate, or the like are used. For example, a substrate in a thin film shape such as a nonwoven fabric, a woven fabric and a microporous film, to which the inorganic substance in a fiber shape or a particle shape is stuck, may be used as a separator. A substrate in a thin film shape with a pore diameter of from 0.01 μm to 1 μm and a thickness of from 5μm to 50 μm may be used favorably.

Further, a complex porous layer formed from the inorganic substance in a fiber shape or a particle shape using a binder such as a resin is used as a separator. Alternatively, the complex porous layer may be formed on a surface of a positive electrode or a negative electrode as a separator. For example, a complex porous layer may be formed on a surface of a positive electrode, or on a side of a separator facing a positive electrode by binding alumina particles with a 90% particle size (D90) of less than 1μm using a fluorinated resin as a binder.

<Electrolyte Solution>

An electrolyte solution contains a lithium salt (namely, electrolyte), and a nonaqueous solvent dissolving thereof.

The nonaqueous solvent includes dimethyl carbonate (DMC). As described above, the nonaqueous solvent includes dimethyl carbonate, thereby resulting in a tendency to enhance a charge and discharge cycle performance.

A content of dimethyl carbonate is preferably more than 70% by volume, and more preferably 80% by volume or more, with respect to the total amount of the nonaqueous solvent. When a content of dimethyl carbonate is more than 70% by volume, furthermore 80% by volume or more, with respect to the total amount of the nonaqueous solvent, a charge and discharge cycle performance tends to be enhanced even when a capacity ratio of a negative electrode capacity and a positive electrode capacity (negative electrode capacity/positive electrode capacity) is 1 or less. A content of dimethyl carbonate is more preferably 85% by volume or more, and still more preferably 90% by volume or more with respect to the total amount of the nonaqueous solvent. While a content of dimethyl carbonate with respect to the total mass of the nonaqueous solvent may be 100% by volume, such a content is preferably 95% by volume or less from the viewpoint of improvement of safety.

The nonaqueous solvent includes any other nonaqueous solvent than dimethyl carbonate. Examples of such other nonaqueous solvent include ethylene carbonate (EC), trifluoroethyl phosphate (TFEP), ethyl methyl sulfone (EMS), diethyl carbonate (DEC), vinylene carbonate (VC), methyl ethyl carbonate, y-butyrolactone, acetonitrile, 1,2-dimethoxyethane, dimethoxymethane, tetrahydrofuran, dioxolane, methylene chloride and methyl acetate. Such other nonaqueous solvents may be used singly, or in combination of two or more kinds thereof.

A content of such other nonaqueous solvent is preferably 20% by volume or less, more preferably 15% by volume or less, and still more preferably 10% by volume or less with respect to the total amount of the nonaqueous solvent. While a content of such other nonaqueous solvent may be 0% by volume, such a content is preferably 5% by volume or more from the viewpoint of improvement of safety.

When a nonaqueous solvent having a high flash point, such as ethylene carbonate or trifluoroethyl phosphate, is used, such a nonaqueous solvent may be inferior in oxidation resistance, while the electrolyte solution becomes safer. Therefore, when such other nonaqueous solvent than dimethyl carbonate is used, a content of such other nonaqueous solvent is preferably 20% by volume or less with respect to the total mass of the nonaqueous solvent, thereby resulting in a tendency to enable reduction in charge and discharge cycle performance to be suppressed.

Examples of a lithium salt include LiPF₆, LiBF₄, LiFSI (lithium bis(fluorosulfonyl)imide), LiTF SI (lithium bis(trifluoromethanesulfonyl)imide), LiClO₄, LiB (C₆H₅)₄, LiCH₃SO₃, LiCF₃SO₃, LiN(SO₂F)₂, LiN(SO₂CF₃)₂, and LiN(SO₂CF₂CF₃)₂. The lithium salts may be used singly or in a combination of two or more kinds thereof.

Among them, LiPF6 is preferable judging by solubility in a nonaqueous solvent, and charge and discharge characteristics, input-output performance, charge and discharge cycle performance or the like when a lithium-ion secondary battery is assembled.

A concentration of the lithium salt in an electrolyte solution is preferably from 1.2 mol/L to 2.0 mol/L, more preferably from 1.5 mol/L to 2.0 mol/L, and still more preferably from 1.7 mol/L to 2.0 mol/L, from the viewpoint of improvement of safety. By adjusting the concentration of the lithium salt high so as to be from 1.2 mol/L to 2.0 mol/L, a flash point of an electrolyte solution increases to be safer.

The electrolyte solution may include an additive, if necessary. When the electrolyte solution includes an additive, there is a tendency that storage characteristics at high temperatures, charge and discharge cycle performance, and input-output performance are enhanced.

There is no particular restriction on an additive, insofar as it is an additive for a nonaqueous electrolyte solution of a lithium-ion secondary battery. Specifically, examples of an additive include a heterocyclic compound including nitrogen, sulfur, or nitrogen and sulfur, a cyclic carboxylic acid ester, a fluorine-containing cyclic carbonate, a fluorine-containing borate ester, and a compound having an unsaturated bond in the molecule. Further, in addition to the above additive, another additive, such as an overcharge prevention agent, a negative electrode film-form agent, a positive electrode protection agent, and a high input-output agent, may be used according to a required function.

(Capacity Ratio of Negative Electrode Capacity and Positive Electrode Capacity)

In the lithium-ion secondary battery in the present embodiment, a capacity ratio of a negative electrode capacity and a positive electrode capacity (negative electrode capacity/positive electrode capacity) is preferably 0.7 or more but less than 1 from the viewpoint of input characteristics. When such a capacity ratio is 0.7 or more, a battery capacity tends to be enhanced, thereby imparting a high energy density. When such a capacity ratio is less than 1, a decomposition reaction of the electrolyte solution due to an increase in potential of the positive electrode tends to be hardly caused, thereby resulting in improvement in charge and discharge cycle performance of the lithium-ion secondary battery. The capacity ratio is more preferably from 0.75 to 0.95 from the viewpoint of energy density and input characteristics.

The “negative electrode capacity” and the “positive electrode capacity” each mean the maximum capacity which can be reversibly utilized, the maximum capacity being obtained when an electrochemical cell including metallic lithium as a counter electrode is formed to perform constant current and constant voltage charge and then constant current discharge.

The negative electrode capacity represents “discharge capacity of negative electrode” and the positive electrode capacity represents “discharge capacity of positive electrode”. Such “discharge capacity of negative electrode” is defined as one calculated in a charge and discharge apparatus in leaving of a lithium ion inserted into the negative electrode active material. Such “discharge capacity of positive electrode” is defined as one calculated in a charge and discharge apparatus in leaving of a lithium ion from the positive electrode active material.

For example, when the positive electrode active material is a lithium nickel manganese complex oxide and the negative electrode active material is a lithium titanium complex oxide, the “positive electrode capacity” and the “negative electrode capacity” mean respective capacities which are obtained when the charge and discharge where voltage ranges are from 4.95 V to 3.5 V and from 2 V to 1 V, respectively, and a current density in constant current charge and constant current discharge is 0.1mA/cm² is performed in the electrochemical cell for evaluation.

<Shapes and the like of Lithium-ion Secondary Battery>

A lithium-ion secondary battery in the present embodiment may take various shapes, such as cylindrical, laminated-shaped layer-built, and coin-shaped. In any shape, a separator is inserted between a positive electrode and a negative electrode to form an electrode body. A positive electrode current collector and a negative electrode current collector are connected by collecting leads respectively with a positive electrode terminal and a negative electrode terminal, which connect with the outside, and the electrode body is packed together with an electrolyte solution in a battery case to be sealed.

Next, one configuration example where the lithium-ion secondary battery in the present embodiment is a 18650 (cylindrical) battery and one configuration example where the lithium-ion secondary battery in the present embodiment is a laminated battery will be described with reference to the drawings. The size of each member in each of the drawings is conceptual, and a relative relationship in size between members is not limited to the size. The same reference numeral is provided to members having substantially the same function as each other throughout all the drawings, and any description overlapped may be omitted.

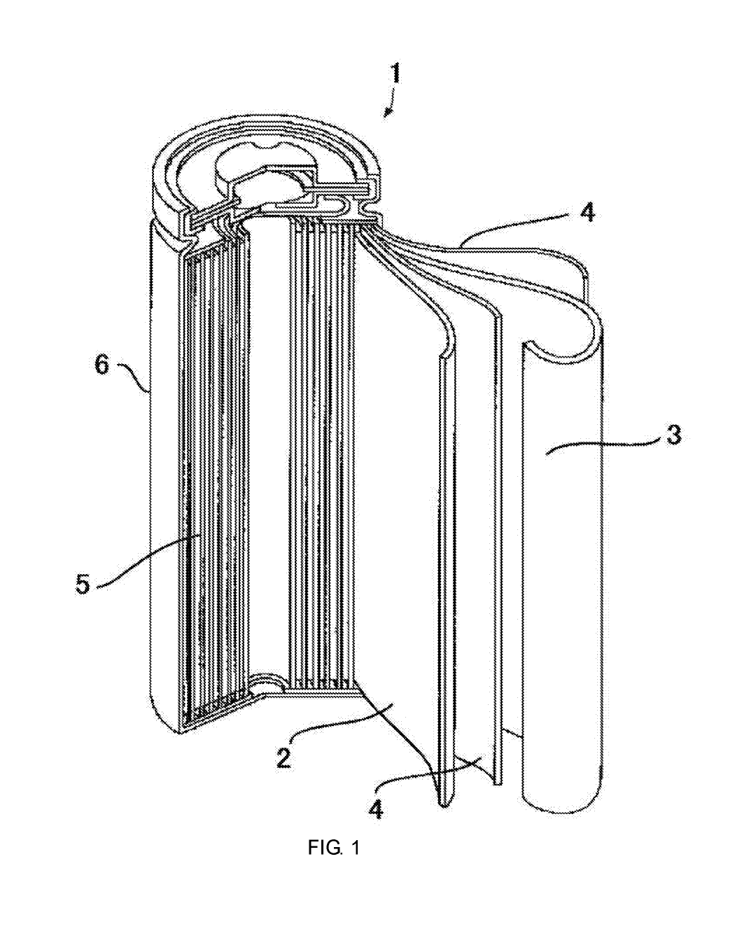

FIG. 1 is a perspective cross-sectional view illustrating one configuration example where the lithium-ion secondary battery in the present embodiment is a 18650 (cylindrical) battery.

As illustrated in FIG. 1, a lithium-ion secondary battery 1 has a cylindrical battery container 6 which is made of steel plated with nickel and which has a bottom. The battery container 6 accommodates an electrode assembly 5 where a strip form positive plate 2 and a negative plate 3 are wound up spirally in cross section with a separator 4 being interposed therebetween. The electrode assembly 5 is configured so that the positive plate 2 and the negative plate 3 are wound up spirally in cross section with a separator 4 as a polyethylene porous sheet being interposed therebetween. The separator 4 is set to have, for example, a width of 58 mm and a thickness of 20 μm. A ribbon-like positive electrode tab terminal made of aluminum, whose one end portion is secured to the positive plate 2, is derived on an upper end surface of the electrode assembly 5. Other end portion of the positive electrode tab terminal is jointed to a lower surface of a disc-like battery case lid, which is disposed above the electrode assembly 5 and serves as an external terminal of the positive electrode, by ultrasonic welding. On the other hand, a ribbon-like negative electrode tab terminal made of copper, whose one end portion is secured to the negative plate 3, is derived on a lower end surface of the electrode assembly 5. Other end portion of the negative electrode tab terminal is jointed to an inner bottom of the battery container 6 by resistance welding. Accordingly, the positive electrode tab terminal and the negative electrode tab terminal are derived opposite to each other on both end portions of the electrode assembly 5. The entire circumference on the outer periphery of the electrode assembly 5 is provided with an insulation covering omitted in illustration. The battery case lid is secured by swaging to an upper portion of the battery container 6 via an insulating resin gasket. Therefore, the interior of the lithium-ion secondary battery 1 is hermetically closed. The battery container 6 includes an electrolyte solution poured therein, not illustrated.

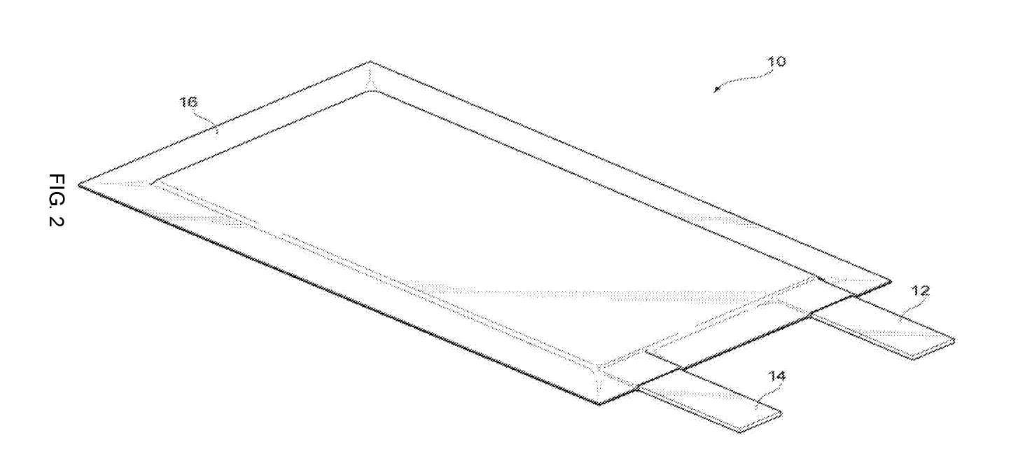

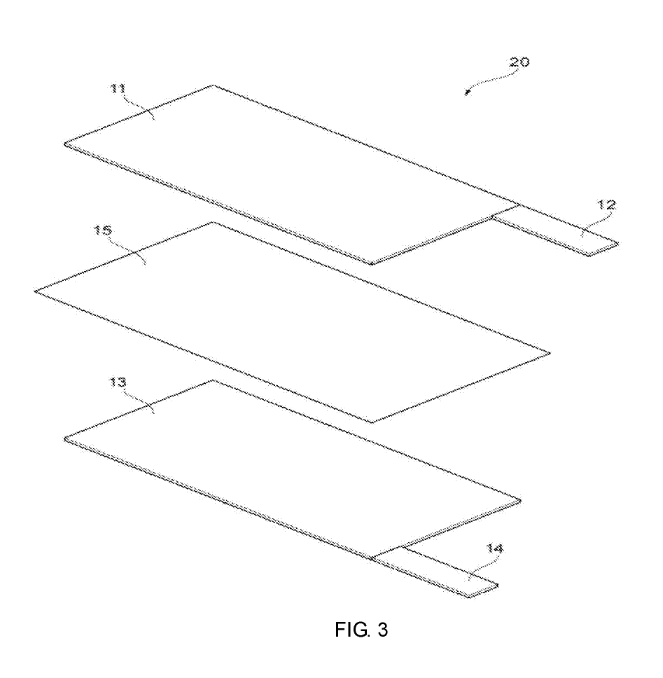

FIG. 2 is a perspective view illustrating one configuration example where the lithium-ion secondary battery in the present embodiment is a laminated battery. FIG. 3 is a perspective view illustrating a positive plate, a negative plate and a separator forming an electrode assembly of the lithium-ion secondary battery in FIG. 2.

In a lithium-ion secondary battery 10 in FIG. 2, an electrode assembly 20 and an electrolyte solution for a lithium-ion secondary battery are packed in a battery outer package 16 made of a laminate film, and a positive electrode collector tab 12 and a negative electrode collector tab 14 are extracted out of the battery outer package 16.

As shown in FIG. 3, an electrode assembly 20 is formed by laminating a positive plate 11 provided with a positive electrode collector tab 12, a separator 15, and a negative plate 13 provided with a negative electrode collector tab 14. In this regard, the dimension, shape or the like of a positive plate, a negative plate, a separator, an electrode assembly, and a battery may be optional, and not limited to those shown in FIG. 2 and FIG. 3.

A material of the battery outer package 16 includes aluminum, copper, stainless steel, or the like.

[Charge and Discharge System of Lithium-ion Secondary Battery and Charge and Discharge Method thereof]

A charge and discharge system of the lithium-ion secondary battery in the present embodiment includes the lithium-ion secondary battery in the present embodiment; a charge controller that controls an end-of-charge voltage of the lithium-ion secondary battery within a range from 3.4 V to 3.8 V; and a discharge controller that controls an end-of-discharge voltage of the lithium-ion secondary battery within a range from 2.0 V to 2.8 V. The discharge controller preferably controls an end-of-discharge voltage within a range from 2.6 V to 2.8 V from the viewpoint of more enhancement in charge and discharge cycle performance. The charge controller and the discharge controller can be configured from, for example, a control IC (Integrated Circuit).

A charge and discharge method of the lithium-ion secondary battery in the present embodiment includes a charge step of performing charge with setting an end-of-charge voltage of the lithium-ion secondary battery in the present embodiment in a range from 3.4 V to 3.8 V, and a discharge step of performing discharge with setting an end-of-discharge voltage of the lithium-ion secondary battery in a range from 2.0 V to 2.8 V. In the discharge step, discharge is preferably performed with setting an end-of-discharge voltage in a range from 2.6 V to 2.8 V, from the viewpoint of more enhancement in charge and discharge cycle performance.

The charge and discharge system and the charge and discharge method thus enable an initial capacity, and a charge and discharge cycle performance of the lithium-ion secondary battery in the present embodiment to be enhanced.

Examples of a charge mode of the lithium-ion secondary battery in the present embodiment include a constant current-constant voltage charge (CCCV) mode where charge is performed to an upper limit voltage set in advance due to a constant current and thereafter discharge is performed with the voltage being kept.

The entire contents of the disclosures by Japanese Patent Application No. 2016-035313 filed on Feb. 26, 2016 are incorporated herein by reference.

All the literature, patent application, and technical standards cited herein are also herein incorporated to the same extent as provided for specifically and severally with respect to an individual literature, patent application, and technical standard to the effect that the same should be so incorporated by reference.

### EXAMPLES

The present embodiment will be described in more details below by way of Examples, provided that the invention be not restricted in any way by the following Examples.

### Examples 1 to 11 and Comparative Examples 1 to 5

Mixed were 93 parts by mass of a lithium nickel manganese complex oxide (LiNi_{0.5}Mn_{1.5}O₄) having a spinel structure, as a positive electrode active material, 5 parts by mass of acetylene black (manufactured by Denka Company Limited.) as an electroconductive material, and 2 parts by mass of a copolymer (binder resin composition of Synthesis Example 1) obtained by addition of acrylic acid and a straight chain ether group to a polyacrylonitrile structure, as a binder, and a proper amount of N-methyl-2-pyrrolidone was added thereto and kneaded, thereby obtaining a pasty positive electrode material mixture. Both surfaces of aluminum foil having a thickness of 20 μm, as a current collector for a positive electrode, were substantially uniformly and homogeneously coated with the positive electrode material mixture so that a solid mass of the positive electrode material mixture was 145 g/m². Thereafter, a drying treatment was made, and consolidation was made by pressing until a density of 2.4 g/cm³ was achieved, thereby obtaining a sheet-like positive electrode.

Mixed were 91 parts by mass of lithium titanate being one lithium titanium complex oxide, as a negative electrode active material, 4 parts by mass of carbon black (manufactured by Denka Company Limited.) as an electroconductive material, and 5 parts by mass of polyvinylidene fluoride as a binder, and a proper amount of N-methyl-2-pyrrolidone was added thereto and kneaded, thereby obtaining a pasty negative electrode material mixture. Both surfaces of copper foil having a thickness of 10 μm, as a current collector for a negative electrode, were substantially uniformly and homogeneously coated with the negative electrode material mixture so that a solid mass of the negative electrode material mixture was 85 g/m². Thereafter, a drying treatment was made, and consolidation was made by pressing until a density of 1.9 g/cm³ was achieved, thereby obtaining a sheet-like negative electrode.

Each of the positive electrode and the negative electrode was cut to a predetermined size, and the positive electrode cut and the negative electrode cut were wound up with a three-layer separator of polypropylene/polyethylene/polypropylene, having a thickness of 20 μm, being interposed therebetween, thereby forming a roll-like electrode body. The positive electrode had a length of 65 cm, the negative electrode had a length of 70 cm and the separator had a length of 164 cm so that the electrode body here had a diameter of 16.5 mm. The electrode body was equipped with collecting leads, and inserted into a 18650 battery case, and thereafter an electrolyte solution was poured into the battery case. The electrolyte solution used was obtained by dissolving an electrolyte, LiPF₆, in a concentration of 1.7 mol/L in a nonaqueous solvent shown in Table 1 below. Finally, the battery case was sealed, thereby finishing a lithium-ion secondary battery.

Synthesis Example of the binder used for the positive electrode is shown below.

### Synthesis Example 1

A 3-L separable flask equipped with a stirrer, a thermometer, a condenser and a nitrogen gas introduction tube was charged with 1804 g of purified water, the temperature was raised to 74° C. with stirring in a condition of a flow rate of nitrogen gas of 200 mL/min, and then flowing of nitrogen gas was stopped. Next, an aqueous solution in which 0.968 g of ammonium persulfate as a polymerization initiator was dissolved in 76 g of purified water was added, and a mixed liquid of 183.8 g of acrylonitrile as a nitrile group-containing monomer, 9.7 g (a proportion of 0.039 mol with respect to 1 mol of acrylonitrile) of acrylic acid as a carboxyl group-containing monomer and 6.5 g (a proportion of 0.0085 mol with respect to 1 mol of acrylonitrile) of methoxy triethylene glycol acrylate (trade name: NK ESTER AM-30G produced by Shin-Nakamura Chemical Co., Ltd.) as a monomer was immediately dropped over 2 hours with the temperature of the reaction system being kept at 74° C.±2° C. Subsequently, an aqueous solution in which 0.25 g of ammonium persulfate was dissolved in 21.3 g of purified water was additionally added to the reaction system suspended, the temperature was raised to 84° C., and then the reaction was allowed to progress for 2.5 hours with the temperature of the reaction system being kept at 84° C.±2° C. Thereafter, the resultant was cooled to 40° C. over 1 hour, then stirring was stopped, and the resultant was left to be cooled at room temperature overnight, thereby obtaining a reaction liquid in which a binder resin composition was precipitated. The reaction liquid was subjected to suction filtration, and a wet precipitate recovered was washed with 1800 g of purified water three times and then dried in vacuum at 80° C. for 10 hours, thereby obtaining a binder resin composition.

[Evaluation]

(Initial Capacity)

The lithium-ion secondary battery was subjected to constant current charge at 25° C. and at a current value of 0.2 C and an end-of-charge voltage Vc described in Table 1 by use of a charge and discharge apparatus (BATTERY TEST UNIT, manufactured by IEM), and thereafter subjected to constant voltage charge at an end-of-charge voltage Vc described in Table 1 until a current value of 0.01 C was achieved. The unit “C” used as the unit of the current value means “current value (A)/battery capacity (Ah)”. After a rest for 15 minutes, constant current discharge was performed at a current value of 0.2 C and an end-of-discharge voltage Vd described in Table 1. After such charge and discharge was repeated under the charge and discharge conditions three times, constant current charge was performed at a current value of 0.2 C and an end-of-charge voltage Vc described in Table 1, and thereafter constant voltage charge was performed at an end-of-charge voltage Vc described in Table 1 until a current value of 0.01 C was achieved. After a rest for 15 minutes, constant current discharge was performed at a current value of 0.2 C and an end-of-discharge voltage Vd described in Table 1. A relative initial capacity value was calculated from the discharge capacity obtained here and the discharge capacity in Example 1 by use of the following Formula. The results obtained are shown in Table 1.

Initial capacity (%)=(discharge capacity/discharge capacity in Example 1)×100

(Charge and Discharge Cycle Performance)

The lithium-ion secondary battery, a discharge capacity of which was measured as described above, was used to perform constant current charge at 25° C. and at a current value of 1 C and an end-of-charge voltage Vc described in Table 1 after a rest for 15 minutes of discharge, and thereafter to perform constant voltage charge at an end-of-charge voltage Vc described in Table 1 until a current value of 0.01 C was achieved. After a rest for 15 minutes, constant current discharge was performed at 25° C. and at a current value of 1 C and an end-of-discharge voltage Vd described in Table 1, and the discharge capacity at the 1-st cycle (1-cycle discharge capacity) was measured. Such charge and discharge was repeated under the charge and discharge conditions 1000 times, and the discharge capacity at the 1000-th cycle (1000-cycle discharge capacity) was measured. A charge and discharge cycle performance was then calculated according to the following Formula. The results obtained are shown in Table 1.

Charge and discharge cycle performance (%)=(1000-cycle discharge capacity/1-cycle discharge capacity)×100

TABLE 1

| | | | Initial | Charge and | | | | | |
|---|---|---|---|---|---|---|---|---|---|
| | Vc | Vd | Capacity | Discharge Cycle | Solvent Ratio (% by volume) | | | | |
| | (V) | (V) | (%) | Performance. | DMC | EC | TFEP | EMS | DEC |
| Example 1 | 3.8 | 2.0 | 100 | 93 | 80 | 20 | | | |
| Example 2 | 3.6 | 2.0 | 99 | 95 | 80 | 20 | | | |
| Example 3 | 3.4 | 2.0 | 98 | 97 | 80 | 20 | | | |
| Example 4 | 3.8 | 2.8 | 87 | 93 | 80 | 20 | | | |
| Example 5 | 3.6 | 2.8 | 86 | 97 | 80 | 20 | | | |
| Example 6 | 3.4 | 2.8 | 85 | 99 | 80 | 20 | | | |
| Example 7 | 3.8 | 2.0 | 100 | 95 | 95 | | 5 | | |
| Example 8 | 3.8 | 2.0 | 100 | 90 | 95 | | | 5 | |
| Example 9 | 3.8 | 2.0 | 100 | 95 | 95 | | | | 5 |
| Example 10 | 3.8 | 2.0 | 100 | 90 | 75 | 25 | | | |
| Example 11 | 3.8 | 2.0 | 100 | 85 | 70 | 30 | | | |
| Comparative | 4.0 | 2.0 | 101 | 15 | 80 | 20 | | | |
| Example 1 | | | | | | | | | |
| Comparative | 3.2 | 2.0 | 25 | 100 | 80 | 20 | | | |
| Example 2 | | | | | | | | | |
| Comparative | 3.8 | 3.0 | 65 | 100 | 80 | 20 | | | |
| Example 3 | | | | | | | | | |
| Comparative | 3.8 | 1.5 | 101 | 70 | 80 | 20 | | | |
| Example 4 | | | | | | | | | |
| Comparative | 3.8 | 2.0 | 100 | 50 | | 20 | | | 80 |
| Example 5 | | | | | | | | | |

In Table 1, any blank column indicates no corresponding component contained.

It could be confirmed as shown in Table 1 that each of Examples 1 to 11, where an end-of-charge voltage Vc was in a range from 3.4 V to 3.8 V and an end-of-discharge voltage Vd was in a range from 2.0 V to 2.8 V, was more excellent in charge and discharge cycle performance than each of Comparative Examples 1 and 4, where an end-of-charge voltage Vc was more than 3.8 V or an end-of-discharge voltage Vd was less than 2.0 V.

In particular, each of Examples 1 to 10, where a content of DMC with respect to the total amount of the nonaqueous solvent was more than 70% by volume, was more excellent in charge and discharge cycle performance than Example 11 where such a content of DMC was 70% by volume.

It could also be confirmed that each of Examples 1 to 11, where an end-of-charge voltage Vc was in a range from 3.4 V to 3.8 V and an end-of-discharge voltage Vd was in a range from 2.0 V to 2.8 V, was more excellent in initial capacity than each of Comparative Examples 2 and 3, where an end-of-charge voltage Vc was less than 3.4 V or an end-of-discharge voltage Vd was more than 2.8 V.

It could be further confirmed that each of Examples 1 to 11, where the nonaqueous solvent included DMC, was more excellent in charge and discharge cycle performance than Comparative Example 5 where the nonaqueous solvent included no DMC.

### Examples 12 to 20 and Comparative Example 6 to 10

(Production of Positive Plate and Negative Plate)

Mixed were 93 parts by mass of a lithium nickel manganese complex oxide (LiNi_{0.5}Mn_{1.5}O₄) having a spinel structure, as a positive electrode active material, 5 parts by mass of acetylene black (manufactured by Denka Company Limited.) as an electroconductive material, and 2 parts by mass of a copolymer (binder resin composition of Synthesis Example 1) obtained by addition of acrylic acid and a straight chain ether group to a polyacrylonitrile structure, as a binder, and a proper amount of N-methyl-2-pyrrolidone was added thereto and kneaded, thereby obtaining a pasty positive electrode material mixture. One surface of aluminum foil having a thickness of 20 as a current collector for a positive electrode, was substantially uniformly and homogeneously coated with the positive electrode material mixture so that a solid mass of the positive electrode material mixture was 140 g/m². Thereafter, a drying treatment was made, thereby obtaining a dry coating film. The dry coating film was consolidated by pressing until a density in terms of a solid mass of the positive electrode material mixture reached 2.3 g/cm³, thereby producing a sheet-like positive electrode. A positive electrode material mixture layer had a thickness of 60 The positive electrode was cut to a size of a width of 30 mm and a length 45 mm, thereby providing a positive plate, and a positive electrode collector tab was attached to the positive plate as illustrated in FIG. 3.

Mixed were 91 parts by mass of lithium titanate being one lithium titanium complex oxide, as a negative electrode active material, 4 parts by mass of acetylene black (manufactured by Denka Company Limited.) as an electroconductive material, and 5 parts by mass of polyvinylidene fluoride as a binder, and a proper amount of N-methyl-2-pyrrolidone was added thereto and kneaded, thereby obtaining a pasty negative electrode material mixture. One surface of copper foil having a thickness of 10 as a current collector for a negative electrode, was substantially uniformly and homogeneously coated with the negative electrode material mixture so that a solid mass of the negative electrode material mixture was 85 g/m². Thereafter, a drying treatment was made, thereby obtaining a dry coating film. The dry coating film was consolidated by pressing until a density in terms of a solid mass of the negative electrode material mixture reached 1.9 g/cm³, thereby producing a sheet-like negative electrode. A negative electrode material mixture layer had a thickness of 45 The negative electrode was cut to a size of a width of 31 mm and a length of 46 mm, thereby providing a negative plate, and a negative electrode collector tab was attached to the negative plate as illustrated in FIG. 3.

(Production of Electrode Assembly)

The positive plate produced and the negative plate produced were located opposite to each other with a three-layer separator of polypropylene/polyethylene/polypropylene, having a thickness of 20 μm, a width of 35 mm and a length of 50 mm, being interposed therebetween, thereby producing a layered electrode assembly.

(Preparation of Electrolyte Solution)

An electrolyte, LiPF₆, was dissolved in a concentration of 2.0 mol/L in a nonaqueous solvent shown in Table 2 below, thereby preparing an electrolyte solution.

(Production of Lithium-ion Secondary Battery)

As illustrated in FIG. 2, the electrode assembly was accommodated in a battery outer package formed by an aluminum laminate film, and also the electrolyte solution was poured into the battery outer package and thereafter an opening of a battery container was sealed so that the positive electrode collector tab and the negative electrode collector tab were externally taken out, thereby producing a lithium-ion secondary battery of each of Examples 12 to 20 and Comparative Examples 6 to 10. The aluminum laminate film was a laminated body of polyethylene terephthalate (PET) film/aluminum foil/sealant layer (polypropylene or the like).

[Evaluation]

(Initial Capacity)

The lithium-ion secondary battery was subjected to constant current charge at 25° C. and at a current value of 0.2 C and an end-of-charge voltage Vc described in Table 2 by use of a charge and discharge apparatus (BATTERY TEST UNIT, manufactured by IEM). After a rest for 15 minutes, constant current discharge was performed at a current value of 0.2 C and an end-of-discharge voltage Vd described in Table 2. Such charge and discharge was repeated under the charge and discharge conditions three times. A relative initial capacity value was calculated from the discharge capacity at the 3-rd cycle and the discharge capacity in Example 12 by use of the following Formula. The results obtained are shown in Table 2.

Initial capacity (%)=(discharge capacity/discharge capacity in Example 12)×100

(Charge and Discharge Cycle Performance at High Temperatures)

The lithium-ion secondary battery, a discharge capacity of which was measured as described above, was used to perform constant current charge at 50° C. and at a current value of 1 C and an end-of-charge voltage Vc described in Table 2. After a rest for 15 minutes, constant current discharge was performed at 50° C. and at a current value of 1 C and an end-of-discharge voltage Vd described in Table 2, and the discharge capacity at the 1-st cycle (1-cycle discharge capacity) was measured. Such charge and discharge was repeated under the charge and discharge conditions 300 times, and the discharge capacity at 300-th cycle (300-cycle discharge capacity) was measured. A charge and discharge cycle performance was then calculated according to the following Formula. The results obtained are shown in Table 2.

Charge and discharge cycle performance (%)=(300-cycle discharge capacity/1-cycle discharge capacity)×100

TABLE 2

| | | Initial | Charge and | | | | | |
|---|---|---|---|---|---|---|---|---|
| Vc | Vd | Capacity | Discharge Cycle | Solvent Ratio (% by volume) | | | | |
| (V) | (V) | (%) | Performance. | DMC | EC | TFEP | EMS | DEC |

| | | | | | | | |
|---|---|---|---|---|---|---|---|
| Example 12 | 3.5 | 2.0 | 100 | 80 | 90 | 10 | |
| Example 13 | 3.5 | 2.2 | 97 | 81 | 90 | 10 | |
| Example 14 | 3.5 | 2.4 | 92 | 92 | 90 | 10 | |
| Example 15 | 3.5 | 2.5 | 90 | 96 | 90 | 10 | |
| Example 16 | 3.5 | 2.6 | 88 | 99 | 90 | 10 | |
| Example 17 | 3.5 | 2.8 | 86 | 99 | 90 | 10 | |
| Example 18 | 3.5 | 2.6 | 87 | 95 | 80 | 20 | |
| Example 19 | 3.5 | 2.6 | 88 | 91 | 75 | 25 | |
| Example 20 | 3.5 | 2.5 | 90 | 74 | 70 | 30 | |
| Comparative | 3.5 | 1.8 | 101 | 65 | 90 | 10 | |
| Example 6 | | | | | | | |
| Comparative | 3.5 | 3.0 | 28 | 100 | 90 | 10 | |
| Example 7 | | | | | | | |
| Comparative | 3.2 | 2.6 | 12 | 100 | 90 | 10 | |
| Example 8 | | | | | | | |
| Comparative | 4.0 | 2.6 | 91 | 32 | 90 | 10 | |
| Example 9 | | | | | | | |
| Comparative | 3.5 | 2.6 | 85 | 23 | | 20 | 80 |
| Example 10 | | | | | | | |

In Table 2, any blank column indicates no corresponding component contained.

It could be confirmed as shown in Table 2 that each of Examples 12 to 20, where an end-of-charge voltage Vc was in a range from 3.4 V to 3.8 V and an end-of-discharge voltage Vd was in a range from 2.0 V to 2.8 V, was more excellent in charge and discharge cycle performance at high temperatures than each of Comparative Examples 6 and 9, where an end-of-charge voltage Vc was more than 3.8 V or an end-of-discharge voltage Vd was less than 2.0 V.

In particular, each of Examples 12 to 19, where a content of DMC with respect to the total amount of the nonaqueous solvent was more than 70% by volume, was more excellent in charge and discharge cycle performance at high temperatures than Example 20 where such a content of DMC was 70% by volume.

It could also be confirmed that each of Examples 12 to 20, where an end-of-charge voltage Vc was in a range from 3.4 V to 3.8 V and an end-of-discharge voltage Vd was in a range from 2.0 V to 2.8 V, was more excellent in initial capacity than each of Comparative Examples 7 and 8, where an end-of-charge voltage Vc was less than 3.4 V or an end-of-discharge voltage Vd was more than 2.8 V.

It could be further confirmed that each of Examples 12 to 20, where the nonaqueous solvent included DMC, was more excellent in charge and discharge cycle performance at high temperatures than Comparative Example 10 where the nonaqueous solvent included no DMC.

It has been found from the foregoing results that a lithium-ion secondary battery excellent in initial capacity and charge and discharge cycle performance is obtained when the lithium-ion secondary battery is a lithium-ion secondary battery including a positive electrode including a lithium nickel manganese complex oxide as a positive electrode active material, in which DMC is used as a nonaqueous solvent of an electrolyte solution, an end-of-charge voltage Vc is in a range from 3.4 V to 3.8 V and an end-of-discharge voltage Vd is in a range from 2.0 V to 2.8 V

### EXPLANATION OF REFERENCES

1 lithium-ion secondary battery, 2 positive plate, 3 negative plate, 4 separator, 5 electrode assembly, 6 battery container, 10 lithium-ion secondary battery, 11 positive plate, 12 positive electrode collector tab, 13 negative plate, 14 negative electrode collector tab, 15 separator, 16 battery outer package, 20 electrode assembly

1. A lithium-ion secondary battery comprising:
a positive electrode comprising a lithium nickel manganese complex oxide as a positive electrode active material;
a negative electrode; and
an electrolyte solution; wherein
the electrolyte solution comprises dimethyl carbonate as a nonaqueous solvent, and
an end-of-charge voltage is in a range from 3.4 V to 3.8 V and an end-of-discharge voltage is in a range from 2.0 V to 2.8 V.

2. The lithium-ion secondary battery according to claim 1, wherein the end-of- discharge voltage is in a range from 2.6 V to 2.8 V.

3. The lithium-ion secondary battery according to claim 1, wherein a content of the dimethyl carbonate is more than 70% by volume with respect to a total amount of the nonaqueous solvent.

4. The lithium-ion secondary battery according to claim 1, wherein the negative electrode comprises a lithium titanium complex oxide as a negative electrode active material.
